(19) United States
(12) Patent Application Publication
(10) Pub. No.: US 2012/0258656 A1
(43) Pub. Date: Oct. 11, 2012

(54) Pipe Vent Fitting

(75) Inventor: Leo M. Raimondi, Weymouth, MA (US)

(73) Assignee: Leo Michael Raimondi, Weymouth, MA (US)

(21) Appl. No.: 13/440,866

(22) Filed: Apr. 5, 2012

Related U.S. Application Data
(60) Provisional application No. 61/471,891, filed on Apr. 5, 2011.

(51) Int. Cl. F24F 13/28; B23P 15/16; B23P 11/00

(52) U.S. Cl. 454/367; 29/516; 29/525.13; 29/896.62

(57) ABSTRACT

Devices and methods for protecting pipe vents from clogging due to foreign matter or creatures are disclosed herein. In one aspect, the invention provides a fitting for use with a pipe vent that includes a cylindrical ring-shaped member having an inner lumen extending therethrough between first and second open ends, an outer sidewall defining an outer diameter, and an inner sidewall defining an inner diameter. The invention further includes a mesh screen fixedly mated to the inner sidewall of the ring-shaped member such that the mesh screen extends across the entire inner lumen to prevent large particle debris from passing through the inner lumen. The ring-shaped member can also include a groove formed in an outer surface thereof to permit liquid drainage.

### RELATED APPLICATIONS

This application claims priority to U.S. Provisional Application Ser. No. 61/471,891, filed on Apr. 5, 2011, and entitled “Mesh Screen Bonded to PVC Ring to Prevent Critters Clogging Heating System,” which is hereby incorporated by reference in its entirety.

### FIELD

This invention relates generally to pipe vent fittings. More particularly, this invention relates to improved devices and methods for protecting pipe vents from clogging due to foreign objects or creatures.

### BACKGROUND

Residential and commercial buildings often include one or more pipe vents that extend from the roof or a sidewall of the building. These vents are often connected to heating, air conditioning, or other ventilation systems located within the building. In residential construction especially, pipe vents commonly extend from a sidewall of a building and are left uncapped. In some cases, a downward-facing “elbow” or other fitting is placed on the end of the pipe to prevent rainwater from entering the pipe.

One problem frequently encountered with pipe vents is obstruction and blockage due to foreign matter entering the uncapped pipe. The foreign matter can come from a variety of sources, including living creatures that enter the pipe due to the shelter and/or heat that it provides. In particular, small rodents (e.g., mice), birds, and other creatures often enter the pipes and cause blockages. In addition, flying insects, such as bees, often enter the pipes and begin creating nests, creating undesirable blockage.

Prior art attempts at preventing foreign matter and creatures from entering pipe vents have significant disadvantages. For example, some prior art devices include a mesh screen formed from metal or plastic that is placed directly into the opening of a pipe vent. However, these screens lack any reinforcement and often fall out of the pipe opening because they are not correctly sized to fit within the pipe vent. In addition, plastic screens can freeze and crack, which can cause the screen to fall out of the pipe.

Furthermore, the pipe vents cannot be capped completely because of the need to exhaust air from the connected ventilation system. Proper drainage of condensation is another concern with capping devices, as any build up of liquid can become a source of obstruction, and freeze/thaw cycles can cause damage to the pipe vent or capping device.

Accordingly, there is a need for improved methods and devices for preventing foreign matter, such as living creatures, from entering a pipe vent, while also allowing for effective exhaust of air and liquid.

### SUMMARY

The present invention generally provides devices and methods for protecting pipe vents from clogging due to foreign matter or creatures. In one aspect, the invention provides a fitting for use with a pipe vent that includes a cylindrical ring-shaped member having an inner lumen extending therethrough between first and second open ends, an outer sidewall defining an outer diameter, and an inner sidewall defining an inner diameter. The ring-shaped member has a length extending from the first open end to the second open end. The fitting further includes a mesh screen fixedly mated to the ring-shaped member such that the mesh screen extends across the entire inner lumen to prevent large particle debris from passing through the inner lumen. In an exemplary embodiment, the fitting can also include a groove formed in the outer sidewall thereof and extending between the first and second open ends for allowing passage of condensation.

The fitting can have a number of different features or variations, all of which are considered within the scope of the invention. For example, in some embodiments the mesh screen can include a first substantially planar circular portion with a diameter equal to or less than the inner diameter of the ring-shaped member, and a second portion extending around the perimeter of the first portion and extending transverse to the first portion to form a perimetric flange. The perimetric flange can directly contact the inner sidewall of the ring-shaped member. In other embodiments, the perimetric flange can be fixedly mated to the inner sidewall, for example with an adhesive.

The length and inner and outer diameters of the ring-shaped member can vary. In certain embodiments, the length of the ring-shaped member can be in the range of about 0.5 inches to about 5 inches. In other embodiments, the outer diameter of the outer sidewall can be constant between the first and second open ends of the ring-shaped member. In still other embodiments, the inner diameter of the inner sidewall can be constant between the first and second open ends.

Devices of the present invention can be formed form a variety of materials. For example, in some embodiments the ring-shaped member can be formed from a polymeric material, while in other embodiments the ring-shaped member can be formed from a metal. In some embodiments, the mesh can be formed from a metal, while in other embodiments the mesh can be formed from a polymeric material.

The groove provided in the ring-shaped member can serve to prevent the trapping of liquid within the pipe vent by allowing condensation or other liquid to drain from the pipe vent through the groove. In some embodiments, a depth of the groove can be at least about 50% of the thickness of the sidewall of the ring-shaped member, as measured between the inner and outer sidewalls. In other embodiments, the depth of the groove can be at least about 75% of the thickness of the sidewall of the ring-shaped member.

In another aspect, a fitting for use with a pipe vent is provided that includes a cylindrical non-porous ring-shaped member having an inner lumen extending therethrough between first and second open ends, an outer sidewall defining an outer diameter, and an inner sidewall defining an inner diameter. The ring-shaped member has a length extending from the first open end to the second open end. The fitting further includes a mesh screen having a first substantially planar circular portion with a diameter equal to or less than the inner diameter of the ring-shaped member, and a second portion extending around the perimeter of the first portion and extending transverse to the first portion to form a perimetric flange. The perimetric flange can be fixedly mated directly to the inner sidewall of the ring-shaped member such that the mesh screen extends across the entire inner lumen to prevent large particle debris from passing through the inner lumen.

In still another aspect, a method for manufacturing a fitting for use with a pipe vent is provided, the method including forming a hollow, cylindrical ring-shaped member having an inner lumen extending therethrough and a predetermined length extending between first and second open ends of the ring-shaped member. The method further includes forming a circular-shaped mesh screen, and positioning the mesh screen to contact the ring-shaped member and extend across the entire inner lumen of the ring-shaped member to prevent large particle debris from passing through the inner lumen. The method further includes applying an adhesive to any of the ring-shaped member and the mesh screen to fixedly secure the mesh screen to the ring-shaped member.

In some embodiments, the circular-shaped mesh screen can have a diameter that is greater than a diameter of the inner lumen of the ring-shaped member. In other embodiments, the method can further include advancing the circular-shaped mesh screen into the inner lumen of the ring-shaped member such that an outer perimeter of the circular-shaped mesh screen is deformed to form a circular flange that abuts against an inner sidewall of the ring-shaped member. In certain embodiments, advancing the circular-shaped mesh screen into the inner lumen of the ring-shaped member can include driving a die into the mesh screen and into the inner lumen of the ring-shaped member.

In other embodiments, forming the ring-shaped member can include cutting the ring-shaped member to the predetermined length. Further, in some embodiments forming the mesh screen can include cutting the mesh screen from a sheet of mesh.

In certain embodiments, the method can further include forming a groove in an outer sidewall of the ring-shaped member, the groove extending between the first and second open ends of the ring-shaped member.

In another aspect, a method for preventing large particle debris from passing through a pipe vent is provided that includes providing a fitting having a cylindrical ring-shaped member with an inner lumen extending between first and second open ends and a mesh screen bonded to the ring-shaped member, the mesh screen extending across the entire inner lumen of the ring-shaped member. The method further includes inserting the fitting into an inner lumen of a pipe vent extending out of an outer wall of a dwelling and coupled to a residential heating and/or cooling system, the fitting being held within the inner lumen by a compression fit, and the mesh screen preventing large particle debris from passing through the pipe.

In some embodiments, the ring-shaped member can include a groove formed in an outer surface thereof and extending between the first and second open ends, the groove allowing condensation to flow from the pipe through the groove to thereby drain the pipe. In other embodiments, inserting the fitting into an inner lumen of a pipe vent can include orienting the fitting such that the groove is positioned at the lowest point of the pipe vent. Such positioning can aid in the effective drainage of the pipe vent.

In other embodiments, the method can further include applying an adhesive to any of the inner lumen of the pipe vent and an outer surface of the ring-shaped member prior to inserting the fitting into the inner lumen of the pipe vent.

### BRIEF DESCRIPTION OF THE DRAWINGS

The aspects and embodiments of the invention described above will be more fully understood from the following detailed description taken in conjunction with the accompanying drawings, in which:

FIG. 1 is a front perspective view of one embodiment of a pipe vent fitting of the present invention;

FIG. 2 is a front perspective exploded view of the pipe vent fitting of FIG. 1;

FIG. 3 is a front perspective view of one embodiment of a pipe vent end piece;

FIG. 4 is a side view of the pipe vent end piece of FIG. 3; and

FIG. 5 is a front perspective view of one embodiment of a pipe vent fitting disposed within the pipe vent end piece of FIG. 3.

### DETAILED DESCRIPTION

Certain exemplary embodiments will now be described to provide an overall understanding of the principles of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present invention provides methods and devices for protecting pipe vents from clogging due to foreign matter or living creatures getting inside the pipe vent. In general, a fitting is provided in the form of a ring-shaped member that fits within an inner lumen of a pipe vent. The ring-shaped member has a mesh screen extending across the entire inner lumen thereof to prevent the passage of large particles therethrough. The fitting can be secured within the inner lumen of the pipe vent, e.g., using a compression fit. The ring-shaped member can optionally have one or more grooves formed in an outer surface thereof that allow liquid within the pipe vent to drain out through the groove formed in the ring-shaped member. Devices according to the present invention provide a number of advantages over prior art pipe vent capping devices. For example, the secure fit and mesh screen support provided by the ring-shaped member allow the device to remain securely within the inner lumen of the pipe vent. In addition, the mesh screen can be sized appropriately to prevent the entry of rodents, birds, and even insects (e.g., bees) that often create blockages within pipe vents. Moreover, the addition of a drainage groove can be advantageous to prevent fluid build-up within the pipe vent.

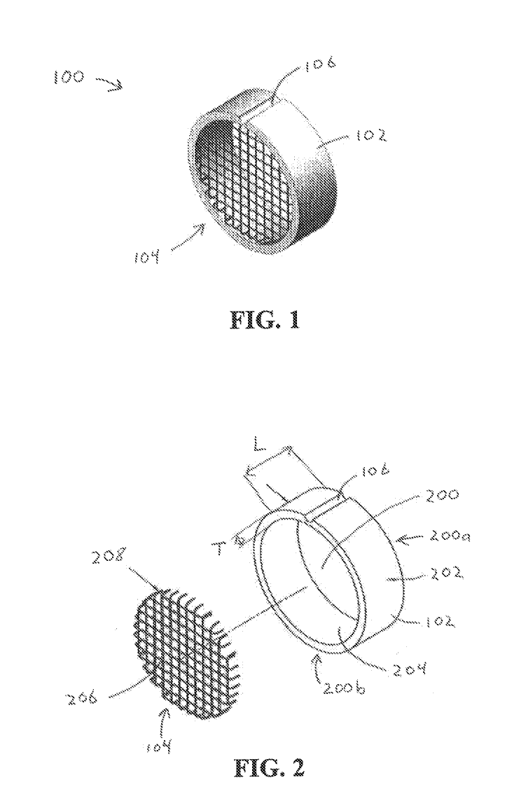

FIG. 1 illustrates one embodiment of a pipe vent fitting. As shown, the pipe vent fitting 100 includes a hollow ring-shaped member 102 that is adapted to fit within an inner lumen of a pipe vent. The pipe vent fitting 100 also includes a mesh screen 104 that extends across an inner lumen of the ring-shaped member 102. The mesh screen 104 can be fixedly secured to the ring-shaped member 102 to prevent the mesh screen from decoupling from the ring-shaped member. Finally, the ring-shaped member 102 can also include one or more grooves 106 formed in an outer surface thereof that are adapted to allow liquid to drain from a pipe vent through the groove. Each of these components is discussed in more detail below.

The ring-shaped member 102, as shown in the exploded view of FIG. 2, is a generally cylindrical member having an inner lumen 200 extending between first and second open ends 200a, 200b. The ring-shaped member 102 includes an outer sidewall 202 that defines an outer diameter of the ring-shaped member, and an inner sidewall 204 that defines an inner diameter of the ring-shaped member. The difference between the outer diameter and inner diameter of the ring-shaped member 102 defines a thickness T of the sidewall of the ring-shaped member. The ring-shaped member 102 also has a length L extending from the first open end 200a to the second open end 200b. In some embodiments, the outer diameter defined by the outer sidewall 202 can be constant over the length L between the first and second open ends of the ring-shaped member 102. In other embodiments, the inner diameter defined by the inner sidewall 204 can also be constant over the length L between the first and second open ends of the ring-shaped member 102.

The ring-shaped member 102 can be formed in a variety of sizes according to the size of the pipe vent in use. For example, standard ventilation system pipe vents in residential properties in the United States often utilize 2-, 3-, 4-, or 6-inch diameter pipe vents. The ring-shaped member 102 can have an outer diameter that is sized appropriately to fit via a compression fit within the inner lumen of any of these pipe vents (or any other size pipe vent). The ring-shaped member 102 can also be formed with a variety of lengths L and thicknesses T. In exemplary embodiments, for example, the ring-shaped member can be formed with a thickness T between about 0.125 inches and about 0.25 inches. Furthermore, the ring-shaped member 102 can be formed with lengths L between about 0.5 inches and about 5 inches. Exemplary lengths include about 0.75 inches, about 1.25 inches, and about 1.5 inches. A person skilled in the art will appreciate that a kit can be provided having fittings in multiple sizes that correspond to the sizes of the standard ventilation system pipe vents.

The ring-shaped member 102 can also be formed from a variety of materials. For example, the ring-shaped member can be formed from polymeric and/or metal materials. In one embodiment, the ring-shaped member can be formed from Polyvinyl Chloride (PVC) of a specified diameter and thickness that is cut to an appropriate length. The use of PVC piping can be preferable in certain embodiments where the pipe vent is also formed from PVC piping, as standard dimensional tolerances can be employed to ensure a precise compression fit. In other embodiments, however, the ring-shaped member 102 can be formed from stainless or galvanized steel, or any other suitable material. In certain exemplary embodiments, the ring-shaped member is formed from a solid, non-porous material.

The mesh screen 104 that extends across the inner lumen of the ring-shaped member 102 can also be formed from a variety of materials. For example, the mesh screen 104 can be formed from stainless or galvanized steel, can have a welded or woven construction, and can utilize a variety of wire diameters. The wire diameters and mesh opening size can be chosen to prevent any undesirable creatures or objects from entering a pipe vent. For example, in one embodiment, the mesh screen 104 can be formed from T-304 alloy stainless steel having a welded construction of 0.028 inch diameter wires that create openings having a dimension of about 0.25 inches. Openings measuring about 0.25 inches or less can be preferable because they prevent bees and other larger insects from passing through the mesh screen.

As shown in FIG. 2, the mesh screen 104 can include a first substantially planar circular portion 206 having a diameter equal to or less than the inner diameter of the ring-shaped member 102. The mesh screen 104 can also include a second portion 208 that extends around the perimeter of the first portion and that extends transverse to the first portion 206 to form a perimetric flange. This perimetric flange or second portion 208 can, in some embodiments, extend in a direction perpendicular to the first portion 206. The perimetric flange 208 can also be in direct contact with the inner sidewall of the ring-shaped member to provide a compression fit of the mesh screen 104 within the inner lumen 200 of the ring-shaped member 102. The perimetric flange 208 can have any height, depending on the size of the mesh screen used. In exemplary embodiments, the flange has a height sufficient to provide a secure fit between the mesh screen and the ring-shaped member. Though the flange can be formed with any height, in exemplary embodiments the height can be between about 0.125 inches and about 1 inch. Furthermore, in some embodiments, the inner sidewall 204 of the ring-shaped member 102 and/or the second portion 208 of the mesh screen 104 can be coated with an adhesive (e.g., PVC cement or other water-impervious adhesive) to bond the mesh screen 104 to the ring-shaped member 102. The use of an adhesive can be preferable to provide a strong bond between the mesh screen 104 and the ring-shaped member 102. A variety of other mating techniques can, however, be used to mate the mesh screen to the inner sidewall, an end wall, the outer sidewall, or any other portion of the ring-shaped member. For example, the end wall of the ring-shaped member can have an annular groove formed therein or a plurality of bores for receiving the perimeter flange on the mesh screen. In other aspects, the entire screen can be substantially planar and it can abut directly against and be adhered to the end wall (i.e., the surface extending between the inner and outer sidewalls). In other embodiments, the screen can include a ring, housing, or other structure that mates to the ring-shaped member, such as by compression fit, mechanical engagement, and/or chemical engagement.

Also shown in FIG. 2 is the groove 106 that can be formed in the outer sidewall 202 of the ring-shaped member 104. As mentioned above, the groove 106 can be included to allow any condensation or other liquid within the pipe vent to drain through the groove and past the pipe vent fitting 100. The groove 106 extends along the outer sidewall 202 between the first and second open ends of the ring-shaped member 102. The groove 106 can have a variety of widths and depths, but is preferably small enough to allow liquid to pass while preventing bees and other large insects from passing through. In some embodiments, the groove 106 can have a depth that is equal to at least about 50% of the thickness T of the sidewall of the ring-shaped member 102. In other embodiments, the groove can have a depth that is equal to about 75% of the thickness T. The groove can also have a variety of widths, and both the width and the depth of the groove can be chosen according to the expected volume of drainage or any other performance criterion. In addition, the groove 106 can, in some embodiments, be formed in a straight line extending between the first and second open ends of the ring-shaped member. In other embodiments, however, the groove 106 may be formed along a curve, s-bend, or other shape extending between the first and second open ends. While a groove is shown, a person skilled in the art will appreciate that other drainage features can be included, such as a bore or lumen extending through the sidewall.

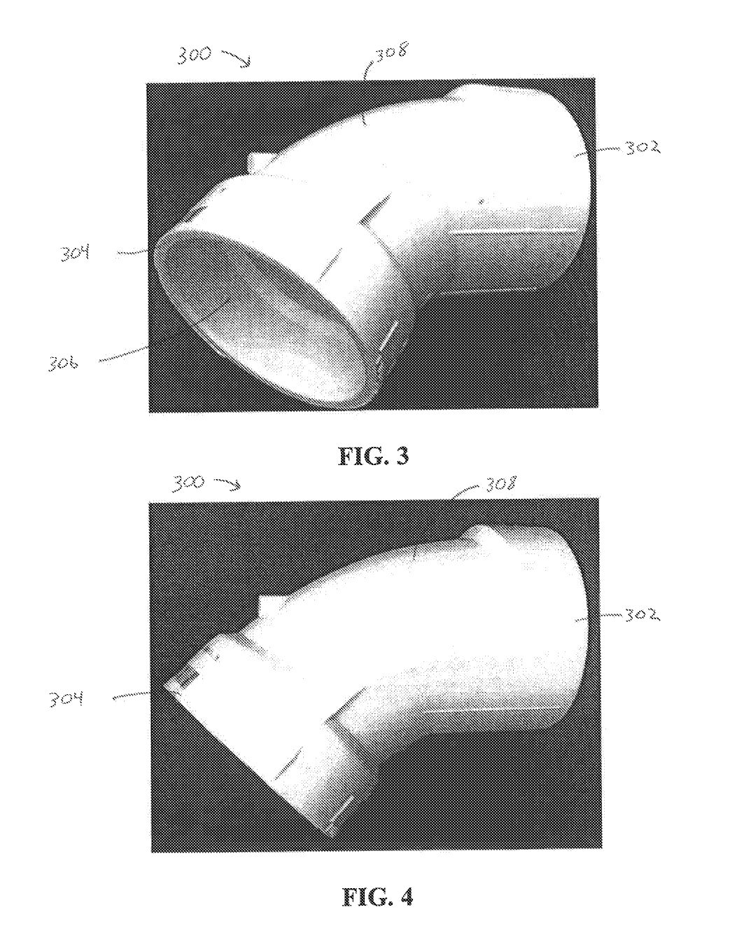

The pipe fitting 100 shown in FIGS. 1 and 2 can be configured to be inserted in an inner lumen of a pipe vent or a pipe vent end piece (e.g., an elbow, 90-degree bend, or other end piece). FIGS. 3 and 4 illustrate one embodiment of a pipe vent end piece 300 that can be commonly found on residential buildings. The end piece 300 includes a proximal end 302 that can be permanently mated to a vent pipe and an open distal end 304 having an inner lumen 306 extending therethrough. The end piece can also include an elbow or other angular bend 308 that can help protect a vent pipe from catching rainwater or other falling debris. While FIGS. 3 and 4 illustrate one embodiment of a vent pipe end piece, one skilled in the art will appreciate that the vent pipe fittings of the present invention can also be fitted to a bare end of a vent pipe that has no end piece disposed thereon.

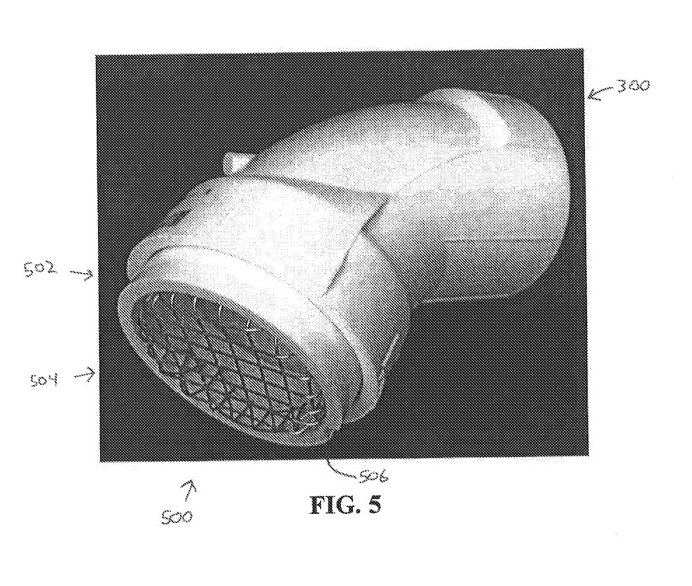

FIG. 5 illustrates one embodiment of a pipe vent fitting 500 disposed within the inner lumen 306 of the end piece 300. As shown in the figure, the pipe vent fitting 500 includes a ring-shaped member 502 that is configured to fit securely within the end piece 300 via a compression fit. In some embodiments, however, an adhesive or other mating technique, such as threads, can be used to further enhance the bond between the end piece 300 and the vent pipe fitting 500. The vent pipe fitting 500 further includes a mesh screen 504 extending across the entire inner lumen of the ring-shaped member 502 to prevent objects and living creatures from entering the inner lumen 306 of the end piece 300. The vent pipe fitting 500 also includes a groove 506 formed in an outer sidewall of the ring-shaped member 502 to allow liquid to drain out of the end piece 300 past the vent pipe fitting 500. The groove 506 is shown positioned at the lowest point of the end piece 300. This arrangement can be preferable because gravity can direct any condensation in other areas of the inner lumen 306 to the position of the groove 506.

To install a pipe vent fitting of the present invention and prevent the clogging of a vent pipe or vent pipe end piece due to foreign objects or creatures, a fitting similar to the pipe vent fitting 500 can be oriented such that a groove (if present) is positioned at the lowest point of the vent pipe or vent pipe end piece. The pipe vent fitting 500 can then be inserted into the inner lumen (e.g., inner lumen 306) of the vent pipe or vent pipe end piece. The pipe vent fitting 500 can be inserted far enough into the vent pipe or vent pipe end piece that the fitting is securely held via an interference or compression fit. Alternatively, in some embodiments, an adhesive can be applied to the outer surface of the pipe fitting and/or the inner surface of the distal end of the vent pipe or vent pipe end piece to enhance the bond between the pipe vent fitting and the vent pipe or vent pipe end piece.

The present invention also provides methods for manufacturing pipe vent fittings. In one embodiment, a cylindrical ring-shaped member of an appropriate size can be formed. A variety of techniques can be used to produce such a member. For example, in some embodiments, a length of PVC pipe having a desired thickness and diameter can be cut to a desired length to form the cylindrical ring-shaped member. In some embodiments, the outer diameter of the ring-shaped member can be selected to fit exactly within the inner lumen of a vent pipe or vent pipe end piece. Exemplary diameters include 2-, 3-, 4-, or 6-inch diameter PVC pipes. Of course, PVC piping is just one example of a material that can be utilized in constructing pipe vent fittings of the present invention, and other rigid materials can also be used to form the ring-shaped member.

A groove can also be formed in the ring-shaped member by filing, drilling, grinding or otherwise removing a portion of the material in the outer sidewall of the ring-shaped member. As discussed above, the groove can be formed with a variety of shapes, widths, and depths, according to user preference and desired performance characteristics.

In some embodiments, a mesh screen can be formed by cutting a mesh screen of a desired size and shape from a sheet of mesh material. One skilled in the art will appreciate additional manners in which a mesh screen of a desired size can be formed. In an exemplary embodiment, a mesh screen is cut into a circular shape with a diameter that is equal to or greater than the inner diameter of the ring-shaped member, and more preferably that is greater than the outer diameter of the ring-shaped member.

To form the pipe vent fitting from the ring-shaped member and the mesh screen, a number of different techniques can be utilized. In one embodiment, the mesh screen can be positioned to contact the ring-shaped member and extend across the entire inner lumen of the ring-shaped member. This can be done, for example, by forming a circular-shaped mesh screen having a diameter that is greater than a diameter of the inner lumen of the ring-shaped member, and advancing the circular-shaped mesh screen into the inner lumen of the ring-shaped member. The circular-shaped mesh screen can be advanced into the inner lumen of the ring-shaped member such that an outer perimeter of the mesh screen is deformed to form a circular flange (e.g., similar to the perimetric flange 208) that abuts against the inner sidewall of the ring-shaped member. The above-described mesh shape can be formed, for example, by placing the circular-shaped mesh screen over a first open end of the ring-shaped member and driving a die into the mesh screen and into the inner lumen of the ring-shaped member. The die can be sized to match, or be slightly thinner than, the inner diameter of the ring-shaped member. The movement of the die can deform the mesh screen and advance it into the inner lumen of the ring-shaped member. The die can be utilized to advance the mesh screen any distance into the ring-shaped member. In some embodiments, the mesh screen can be advanced to a position adjacent to a second open end of the ring-shaped member. In other embodiments, however, the mesh can be advanced to a position between the first and second open ends of the ring-shaped member, such that the mesh screen is recessed within the ring-shaped member.

To securely bond the mesh screen to the ring shaped member, in some embodiments an adhesive can be applied to any of the ring-shaped member and the mesh screen either prior to, or after, positioning the mesh screen with respect to the ring-shaped member. A variety of adhesives can be used for this purpose, including, for example, PVC cement or other silicone-based adhesives. These adhesives can be preferable due to their ability to hold up in wet environments.

One skilled in the art will appreciate that other techniques can be used to secure the mesh screen to the ring-shaped member. For example, the mesh screen can be secured to one end of the ring-shaped member across its inner lumen. In other embodiments, the mesh screen can be seated within an annular groove formed in an inner sidewall of the ring-shaped member. Each of these and other variations on the concepts described above are considered within the scope of the present invention.

The pipe vent fittings can be sold in kits containing a variety of pipe vent fittings of different sizes. The kits can includes pipe vent fittings matched to the standard sizes of pipe vents used in residential or commercial construction projects in a given region. For example, a kit of pipe vent fittings can include fittings sized to match with 2-, 3-, 4-, and 6-inch pipe vents. That is, the pipe vent fittings can have an outer diameter of about 2.5 inches, about 3.5 inches, about 4.5 inches, and about 6.5 inches, respectively. The pipe vent fittings can be cut to any length, but exemplary pipe vent fittings can have lengths of about 0.75 inches, about 1.25 inches, about 1.5 inches, and about 2 inches, respectively.

All papers and publications cited herein are hereby incorporated by reference in their entirety. One skilled in the art will appreciate further features and advantages of the invention based on the above-described embodiments. Accordingly, the invention is not to be limited by what has been particularly shown and described, except as indicated by the appended claims.

Furthermore, the terms “a” and “an” are used herein interchangeably, and are equivalent to the phrase “one or more” as utilized in the present application. The terms “comprising,” “having,” “including,” and “containing” are to be construed as open-ended terms (i.e., meaning “including, but not limited to,”) unless otherwise noted. The terms “about” and “approximately” used above for any numerical values or ranges indicate a suitable dimensional tolerance that allows the composition, part, or collection of elements to function for its intended purpose as described herein. These terms generally indicate a ±10% variation about a central value. Components described herein as being coupled may be directly coupled, or they may be indirectly coupled via one or more intermediate components. The recitation of any ranges of values herein is merely intended to serve as a shorthand method of referring individually to each separate value falling within the range, unless otherwise indicated herein, and each separate value is incorporated into the specification as if it were individually recited. All methods described herein can be performed in any suitable order unless otherwise indicated herein or otherwise clearly contradicted by context. The use of any and all examples, or exemplary language (e.g., “such as”), provided herein is intended merely to better illuminate the invention and does not impose a limitation on the scope of the invention unless otherwise claimed. No language in the specification should be construed as indicating any non-claimed element as essential to the practice of the invention.

What is claimed is:

1. A fitting for use with a pipe vent, comprising:
a cylindrical ring-shaped member having an inner lumen extending therethrough between first and second open ends, an outer sidewall defining an outer diameter and including a groove formed therein extending between the first and second open ends, and an inner sidewall defining an inner diameter, the ring-shaped member having a length extending from the first open end to the second open end; and
a mesh screen fixedly mated to the inner sidewall of the ring-shaped member such that the mesh screen extends across the entire inner lumen to prevent large particle debris from passing through the inner lumen.

2. The fitting of claim 1, wherein the mesh screen comprises a first substantially planar circular portion with a diameter equal to or less than the inner diameter of the ring-shaped member, and a second portion extending around the perimeter of the first portion and extending transverse to the first portion to form a perimetric flange, the perimetric flange being in contact with the inner sidewall of the ring-shaped member.

3. The fitting of claim 2, wherein the perimetric flange is mated to the inner sidewall by an adhesive.

4. The fitting of claim 1, wherein the length of the ring-shaped member is in the range of about 0.5 inches to about 5 inches.

5. The fitting of claim 1, wherein the outer diameter of the outer sidewall is constant between the first and second open ends of the ring-shaped member.

6. The fitting of claim 1, wherein the inner diameter of the inner sidewall is constant between the first and second open ends.

7. The fitting of claim 1, wherein the ring-shaped member is formed from a polymeric material.

8. The fitting of claim 1, wherein the mesh screen is formed from a metal.

9. The fitting of claim 1, wherein a depth of the groove is at least about 50% of the thickness of the sidewall of the ring-shaped member.

10. A fitting for use with a pipe vent, comprising:
a cylindrical non-porous ring-shaped member having an inner lumen extending therethrough between first and second open ends, an outer sidewall defining an outer diameter, and an inner sidewall defining an inner diameter, the ring-shaped member having a length extending from the first open end to the second open end; and
a mesh screen having a first substantially planar circular portion with a diameter equal to or less than the inner diameter of the ring-shaped member, and a second portion extending around the perimeter of the first portion and extending transverse to the first portion to form a perimetric flange, the perimetric flange being fixedly mated directly to the inner sidewall of the ring-shaped member such that the mesh screen extends across the entire inner lumen to prevent large particle debris from passing through the inner lumen.

11. A method for manufacturing a fitting for use with a pipe vent, comprising:
forming a hollow, cylindrical ring-shaped member having an inner lumen extending therethrough and a predetermined length extending between first and second open ends of the ring-shaped member;
forming a circular-shaped mesh screen;
positioning the mesh screen to contact the ring-shaped member and extend across the entire inner lumen of the ring-shaped member to prevent large particle debris from passing through the inner lumen; and
applying an adhesive to any of the ring-shaped member and the mesh screen to fixedly secure the mesh screen to the ring-shaped member.

12. The method of claim 11, wherein the circular-shaped mesh screen has a diameter that is greater than a diameter of the inner lumen of the ring-shaped member.

13. The method of claim 12, further comprising advancing the circular-shaped mesh screen into the inner lumen of the ring-shaped member such that an outer perimeter of the circular-shaped mesh screen is deformed to form a circular flange that abuts against an inner sidewall of the ring-shaped member.

14. The method of claim 13, wherein advancing the circular-shaped mesh screen into the inner lumen of the ring-shaped member comprises driving a die into the mesh screen and into the inner lumen of the ring-shaped member.

15. The method of claim 11, wherein forming the ring-shaped member comprises cutting the ring-shaped member to the predetermined length.

16. The method of claim 11, wherein forming the mesh screen comprises cutting the mesh screen from a sheet of mesh.

17. The method of claim 11, further comprising forming a groove in an outer sidewall of the ring-shaped member, the groove extending between the first and second open ends of the ring-shaped member.

18. A method for preventing large particle debris from passing through a pipe vent, comprising:
providing a fitting having a cylindrical ring-shaped member with an inner lumen extending between first and second open ends and a mesh screen bonded to the ring-shaped member, the mesh screen extending across the entire inner lumen of the ring-shaped member;
inserting the fitting into an inner lumen of a pipe vent extending out of an outer wall of a dwelling and coupled to a residential heating and/or cooling system, the fitting being held within the inner lumen by a compression fit, and the mesh screen preventing large particle debris from passing through the pipe.

19. The method of claim 18, wherein the ring-shaped member includes a groove formed in an outer surface thereof and extending between the first and second open ends, the groove allowing condensation to flow from the pipe through the groove to thereby drain the pipe.

20. The method of claim 19, wherein inserting the fitting into an inner lumen of a pipe vent comprises orienting the fitting such that the groove is positioned at the lowest point of the pipe vent.

21. The method of claim 18, further comprising applying an adhesive to any of the inner lumen of the pipe vent and an outer surface of the ring-shaped member prior to inserting the fitting into the inner lumen of the pipe vent.
